(19) United States
(12) Patent Application Publication
(10) Pub. No.: US 2026/0011739 A1
(43) Pub. Date: Jan. 8, 2026

(54) ELECTRODE FOR LITHIUM SECONDARY BATTERY INCLUDING NON-FIBRILLATED BINDER AND METHOD OF MANUFACTURING SAME

(71) Applicants: Hyundai Motor Company, Seoul (KR); Kia Corporation, Seoul (KR)

(72) Inventors: Hyun Jin Kim, Hwaseong (KR); Yong Il Cho, Hwaseong (KR); Han Nah Song, Hwaseong (KR)

(21) Appl. No.: 18/973,992

(22) Filed: Dec. 9, 2024

(30) Foreign Application Priority Data
Jul. 8, 2024 (KR) 10-2024-0089349

(51) Int. Cl. H01M 4/62; H01M 4/04; H01M 4/13; H01M 4/139

(52) U.S. Cl. CPC H01M 4/623; H01M 4/0435; H01M 4/13; H01M 4/139

(57) ABSTRACT

A dry electrode for a lithium secondary battery includes a non-fibrillated binder and a dry manufacturing method thereof. The dry electrode includes an electrode material including an active material and a binder with which the electrode material is coated, in which the binder includes a copolymer derived from polytetrafluoroethylene (PTFE) and is non-fibrillated. A method of manufacturing an electrode for a lithium secondary battery includes mixing an electrode material comprising an active material and a binder to prepare a mixture in which the electrode material is coated with the binder; and forming the mixture into a film to obtain an electrode, wherein the binder comprises a derivative of polytetrafluoroethylene (PTFE) and is non-fibrillated.

### CROSS-REFERENCE TO RELATED APPLICATION

This application claims, under 35 U.S.C. § 119(a), the benefit of Korean Patent Application No. 10-2024-0089349, filed on Jul. 8, 2024, the entire contents of which are incorporated herein by reference.

### BACKGROUND

### Technical Field

The present disclosure relates to a dry electrode for a lithium secondary battery including a non-fibrillated binder and a dry manufacturing method thereof.

### Background

The components that make up the electrode for a lithium secondary battery include an active material, a conductive material, a binder, etc. The active material determines the capacity of the lithium secondary battery, the conductive material enhances electronic conductivity, and the binder stabilizes the electrode by allowing the components to bind well to each other. Various polymers are used as binders for electrodes, depending on their specific characteristics.

Increasing the thickness of the electrode is necessary to improve energy density, but existing electrode coating technology based on a wet process has limitations in achieving greater electrode thickness. Furthermore, due to the use of a solvent in preparing a slurry, drying for solvent recovery is essential. However, when using a dry process, a thick electrode may be easily formed, and the use of a solvent is obviated, so the dry process is economical and environmentally friendly. Moreover, the dry process is expected to improve process speed.

In order to manufacture an electrode using a dry process, the binder has to be properly unraveled like a skein of thread and spread evenly between the active material and the conductive material to form a network structure. This process is called fibrillation of the binder. A general dry process is to manufacture an electrode by roll pressing a mixture including the fibrillated binder as described above. However, the process for appropriate fibrillation of the binder in the dry electrode mixture using a fibrillation mechanism is very difficult, and when the mixture is transferred, the ratio between components in the mixture may vary due to a difference in distribution of the electrode material and the binder, causing layer separation in the electrode.

### SUMMARY OF THE DISCLOSURE

Therefore, an object of the present disclosure is to provide a dry electrode for a lithium secondary battery that does not use a binder fibrillation mechanism and a dry manufacturing method thereof.

Another object of the present disclosure is to provide a dry electrode for a lithium secondary battery in which components are evenly distributed without layer separation and a dry manufacturing method thereof.

Still another object of the present disclosure is to provide a dry electrode for a lithium secondary battery with excellent processability and a dry manufacturing method thereof.

Yet another object of the present disclosure is to provide a dry electrode for a lithium secondary battery that may be easily manufactured while exhibiting superior performance compared to existing dry electrodes and a dry manufacturing method thereof.

The objects of the present disclosure are not limited to the foregoing. The objects of the present disclosure will be able to be clearly understood through the following description and to be realized by the means described in the claims and combinations thereof.

An embodiment of the present disclosure provides an electrode for a lithium secondary battery, including i) an electrode material including an active material and ii) a binder, wherein the binder may include a copolymer derived from polytetrafluoroethylene (PTFE) and may be non-fibrillated.

In certain preferred aspects, the electrode material may be coated with the binder, and/or the binder may be coated at least in part with the electrode material.

The electrode material may further include a conductive material.

The electrode material may further include at least one selected from the group consisting of a polymer electrolyte, an oxide-based solid electrolyte, a sulfide-based solid electrolyte, and combinations thereof.

The binder may have a Fourier transform infrared spectrum (FT-IR spectrum) showing a peak at a wavenumber of about 980 cm⁻¹ to about 1,000 cm⁻¹.

The binder may include a compound represented by Chemical Formula 1 below.

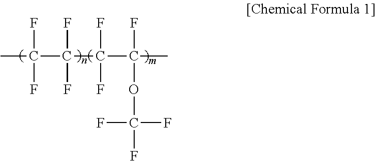

In Chemical Formula 1, each of n and m may be a number from 10 to 1,000, R₁ may be CF₃ or CₓF₂ₓ₊₁, and x may be a number from 2 to 10.

The compound represented by Chemical Formula 1 may include about 10 wt % or less of R₁.

Also, m may be a number from 10 to 1,000.

The electrode may not include a fibrillated material.

The electrode may be a dry electrode.

The electrode may include about 0.1 wt % to about 5 wt % of the binder.

In some embodiments, provided is an electrode for a lithium secondary battery, comprising: an electrode material comprising an active material; and a binder comprising the electrode material, wherein the binder comprises a copolymer derived from polytetrafluoroethylene (PTFE) and is non-fibrillated, and wherein the binder has a Fourier transform infrared spectrum (FT-IR spectrum) showing a peak at a wavenumber of 980 cm⁻¹ to 1,000 cm⁻¹.

In certain preferred aspects, the electrode material may be coated with the binder, and/or the binder may be coated at least in part with the electrode material.

Another embodiment of the present disclosure provides a lithium secondary batter, including a cathode, an anode, and a separator disposed between the cathode and the anode, in which at least one of the cathode or the anode may include the electrode described above.

Still another embodiment of the present disclosure provides a method of manufacturing an electrode for a lithium secondary battery, including preparing a mixture in which an electrode material is coated with a binder by mixing the electrode material including an active material and the binder, and obtaining an electrode by forming the mixture into a film.

The electrode material may be obtained by mixing and compounding the active material and a conductive material at a line speed of 20 m/s or more for 5 minutes or more.

The mixture may be prepared by mixing the electrode material and the binder at a line speed of 20 m/s or more for 5 minutes or more or until an internal temperature of a mixer reaches 80° C. or more.

When supplying the binder to the electrode material, a temperature of the binder may be maintained at −20° C. to 100° C.

Obtaining the electrode may include forming a film by applying heat and pressure to the mixture using a roll press.

As discussed, the method and system suitably include use of a controller or processer.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 shows a lithium secondary battery according to the present disclosure;

FIG. 2 shows a mixture including a fibrillated binder for manufacturing a conventional dry electrode;

FIG. 3 shows an electrode manufactured using the mixture according to FIG. 2;

FIG. 4 shows a mixture for manufacturing an electrode according to the present disclosure;

FIG. 5 shows an electrode material coated with a binder;

FIG. 6 shows a Fourier transform infrared spectrum (FT-IR spectrum) of polytetrafluoroethylene homopolymer;

FIG. 7 shows a Fourier transform infrared spectrum of the binder according to the present disclosure;

FIG. 8 shows the mixture according to Example analyzed using a scanning electron microscope;

FIG. 9 shows the mixture according to Example analyzed using a scanning electron microscope at a different scale from FIG. 8;

FIG. 10 shows the mixture according to Comparative Example 1 analyzed using a scanning electron microscope;

FIG. 11 shows the mixture according to Comparative Example 1 analyzed using a scanning electron microscope at a different scale from FIG. 10;

FIG. 12 shows the mixture according to Comparative Example 2 analyzed using a scanning electron microscope;

FIG. 13 shows the mixture according to Comparative Example 2 analyzed using a scanning electron microscope at a different scale from FIG. 12;

FIG. 14 shows a voltage-capacity graph of a coin cell according to Example.

FIG. 15 shows a voltage-capacity graph of a coin cell according to Comparative Example 1; and

FIG. 16 shows results of evaluation of rate characteristics of the coin cells according to Example and Comparative Example 1.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein.

The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like.

Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

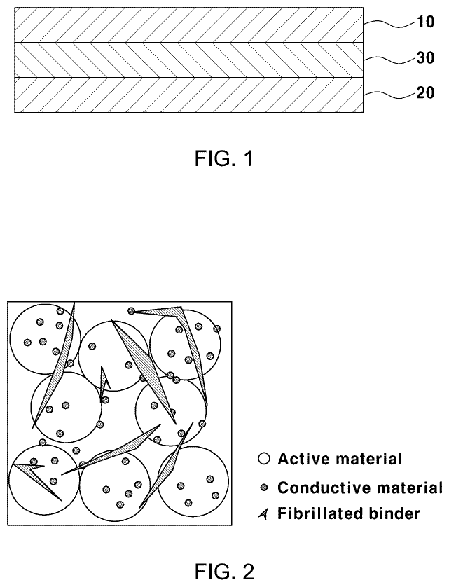

FIG. 1 shows a lithium secondary battery according to the present disclosure. The lithium secondary battery may include a cathode 10, an anode 20, and a separator 30 disposed between the cathode 10 and the anode 20.

The separator 30 may include a porous separator impregnated with a liquid electrolyte or a layered structure including a polymer electrolyte, a solid electrolyte, etc.

At least one of the cathode 10 or the anode 20 may include an electrode according to the present disclosure. Below, the term “electrode” herein may refer to at least one of the cathode 10 or the anode 20.

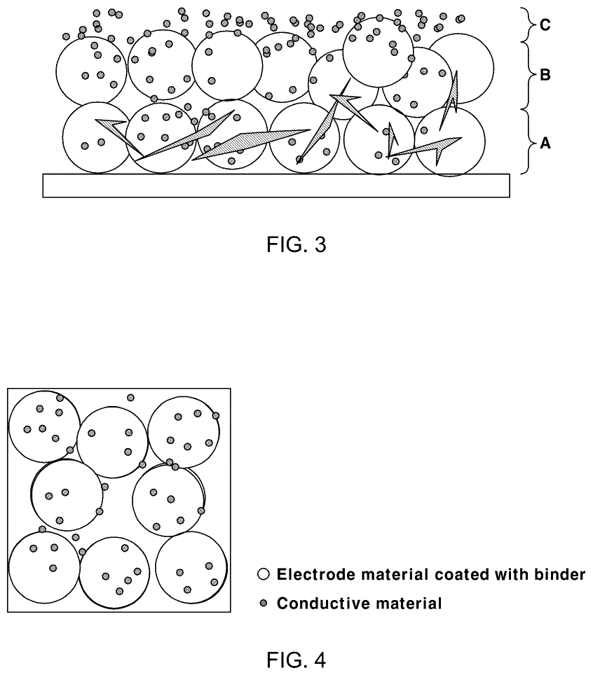

FIG. 2 shows a mixture including a fibrillated binder for manufacturing a conventional dry electrode. The fibrillated binder may be present in the form of a cluster in contact with an active material, a conductive material, etc. When the mixture is transferred by vacuum transfer or gravity drop to form a film, portions clumped together by the fibrillated binder are transferred or dropped first, and relatively light portions are transferred or dropped later. Thereby, as shown in FIG. 3, the conventional dry electrode may be layer-separated in the form of including an A layer including the fibrillated binder, the conductive material, and the active material, a B layer including the conductive material and the active material, and a C layer in which only the conductive material is present. This may cause the electrode thickness or the like to become uneven during roll pressing.

FIG. 4 shows a mixture for manufacturing an electrode according to the present disclosure. The mixture may include an electrode material coated with a binder and a conductive material.

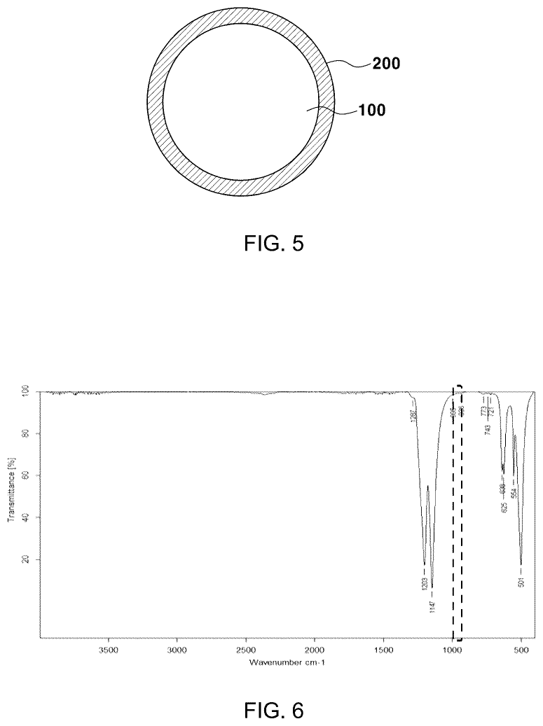

FIG. 5 shows an electrode material coated with a binder. Referring thereto, the electrode according to the present disclosure may include an electrode material 100 including an active material, etc., and a binder 200 with which the electrode material 100 is coated.

Since the non-fibrillated binder 200 is used in the present disclosure, when transferring the mixture, the binder 200 is transferred in a state in which the binder 200 is evenly applied onto and distributed on the surface of the electrode material 100, so the conventional problems described above may not occur.

The electrode material 100 may include an active material, a conductive material, etc.

The active material may include a cathode active material or an anode active material. Examples of the cathode active material may include LCO (LiCoO₂), NCM (Li(Ni,Co,Mn)O₂), NCA (Li(Ni,Co,Al)O₂), LMO (LiMnO₄), LFP (LiFePO₄), sulfur, and the like. Examples of the anode active material may include natural graphite, artificial graphite, MCMB (mesocarbon microbeads), silicon-based active material, and the like.

Examples of the conductive material may include carbon black, acetylene black, carbon fiber, carbon nanotubes, and the like.

When the lithium secondary battery according to the present disclosure is a solid battery, the electrode material 100 may further include at least one selected from the group consisting of a polymer electrolyte, an oxide-based solid electrolyte, a sulfide-based solid electrolyte, and combinations thereof.

Examples of the polymer electrolyte may include poly(ethylene oxide) (PEO), poly(propylene oxide) (PPO), poly(ethylene imine) (PEI), poly(ethylene sulfide) (PES), poly(vinyl acetate) (PVAc), poly(ethylene succinate) (PESc), and the like. Examples of the oxide-based solid electrolyte may include a perovskite-type LLTO (Li₃ₓLa_{2/3-x}TiO₃), a phosphate-based NASICON-type LATP (Li₁₊ₓAlₓTi₂₋ₓ(PO₄)₃), and the like.

Examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—Lil, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers, and Z is any one selected from among Ge, Zn, and Ga), Li₂S—GeS₂, Li₂S—SiS₂—Li₃PO₄, Li₂S—SiS₂—LiₓMO_{y} (in which x and y are positive numbers, and M is any one selected from among P, Si, Ge, B, Al, Ga, and In), Li₁₀GeP₂S₁₂, and the like.

The binder 200 may be applied onto the surface of the electrode material 100. The thickness of the binder 200 is not particularly limited and may be, for example, ones of nanometers (nm) to ones of micrometers (μm).

The binder 200 may include a copolymer derived from polytetrafluoroethylene (PTFE) and may be non-fibrillated.

The binder 200 may be obtained by copolymerizing a tetrafluoroethylene monomer (C₂F₄) with a perfluoroether monomer (C₂F₃OR₁, in which R₁ is a perfluoro functional group), and may include, for example, a perfluoroalkoxy alkane, particularly a compound represented by Chemical Formula 1 below.

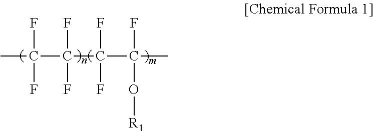

In Chemical Formula 1, each of n and m may be a number from 10 to 1,000, R₁ is CF₃ or CₓF₂ₓ₊₁, and x may be a number from 2 to 10.

The compound represented by Chemical Formula 1 may include 10 wt % or less of R₁. The lower limit of the amount of Ri is not particularly limited and may be determined depending on x of R₁.

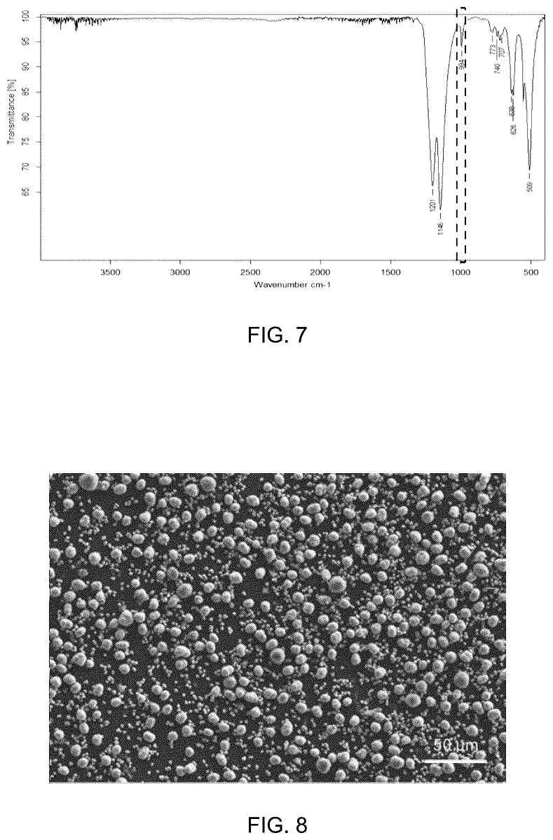

The copolymer derived from polytetrafluoroethylene has thermal and electrical stability equivalent to polytetrafluoroethylene homopolymer, but unlike polytetrafluoroethylene homopolymer, it may be non-fibrillated. Briefly, the binder 200 may be distinct from polytetrafluoroethylene homopolymer. FIG. 6 shows a Fourier transform infrared spectrum (FT-IR spectrum) of polytetrafluoroethylene homopolymer. FIG. 7 shows a Fourier transform infrared spectrum of the binder according to the present disclosure. Specifically, FIG. 7 shows a Fourier transform infrared spectrum of the copolymer derived from polytetrafluoroethylene. As shown in FIG. 7, the binder according to the present disclosure, unlike polytetrafluoroethylene homopolymer, has a Fourier transform infrared spectrum showing a peak at a wavenumber of 980 cm⁻¹ to 1,000 cm⁻¹. Table 1 below shows the characteristic peaks of the polytetrafluoroethylene homopolymer and the binder according to the present disclosure, namely the copolymer derived from polytetrafluoroethylene.

TABLE 1

| | | Characteristic |
|---|---|---|
| Classification | Assignment | peak (cm⁻¹) |
| Polytetrafluoroethylene | CF₂ stretching | 1,202, 1,147 |
| homopolymer | CF deformation | 638, 625 |
| | CF₂ bending | 554, 501 |
| Copolymer derived from | CF₂ stretching | 1,202, 1,147 |
| polytetrafluoroethylene | CF deformation | 638, 625 |
| | CF₂ bending | 554, 501 |
| | CF₃ stretching | 980-1,000 |

Referring to Table 1, the copolymer derived from polytetrafluoroethylene, unlike the polytetrafluoroethylene homopolymer, has a peak observed in the CF₃ stretching region. When the polytetrafluoroethylene homopolymer is subject to shear force, it is fibrillated in the form of a thin skein of thread and weaves the active material, the conductive material, etc., as shown in FIG. 2. The use of the fibrillated binder originating from the polytetrafluoroethylene homopolymer may cause problems during transfer of the mixture described above. In the present disclosure, the copolymer derived from polytetrafluoroethylene, which is not dependent on a fibrillation mechanism, is used as the binder 200 so that the binder 200 is applied onto the electrode material 100 without being fibrillated, thereby solving problems that occur when using polytetrafluoroethylene homopolymer and manufacturing a dry electrode in an easier manner. Therefore, the electrode may be a dry electrode that does not include a fibrillated material.

The electrode may include 0.1 wt % to 5 wt % of the binder 200. If the amount of the binder 200 is less than 0.1 wt %, the electrode material 100 cannot be sufficiently coated therewith and bonding strength in the electrode may decrease, whereas if it exceeds 5 wt %, resistance in the electrode may increase due to the binder 200.

A method of manufacturing the electrode according to the present disclosure may include preparing a mixture in which an electrode material 100 is coated with a binder 200 by mixing the electrode material 100 and the binder 200, and obtaining an electrode by forming the mixture into a film.

The electrode material 100 may be obtained by mixing and compounding an active material and a conductive material at a line speed of 20 m/s or more for 5 minutes or more. The upper limit of the line speed is not particularly limited, and may be set such that the active material and the conductive material are mixed to the extent that they are not deteriorated or destroyed. For example, the line speed may be 100 m/s or less, 90 m/s or less, 80 m/s or less, 70 m/s or less, 60 m/s or less, or 50 m/s or less. The upper limit of the compounding time is not particularly limited, and may be set such that the active material and the conductive material are mixed to the extent that they are not deteriorated or destroyed. For example, the compounding time may be 10 hours or less, 7 hours or less, 4 hours or less, or 1 hour or less.

When the lithium secondary battery according to the present disclosure is a solid battery, at least one selected from the group consisting of a polymer electrolyte, an oxide-based solid electrolyte, a sulfide-based solid electrolyte, and combinations thereof may be further added and compounded along with the active material and the conductive material, preparing an electrode material 100.

The mixture may be prepared by mixing the electrode material 100 and the binder 200 at a line speed of 20 m/s or more for 5 minutes or more or until the internal temperature of a mixer reaches 80° C. or more. The upper limit of the line speed is not particularly limited, and may be set such that the electrode material 100 and the binder 200 are mixed to the extent that they are not deteriorated or destroyed. For example, the line speed may be 100 m/s or less, 90 m/s or less, 80 m/s or less, 70 m/s or less, 60 m/s or less, or 50 m/s or less. The upper limit of the mixing time is not particularly limited, and may be set such that the electrode material 100 and the binder 200 are mixed to the extent that they are not deteriorated or destroyed. For example, the mixing time may be 10 hours or less, 7 hours or less, 4 hours or less, or 1 hour or less. Also, the upper limit of the internal temperature of the mixer at the end of mixing is not particularly limited, and may be set such that the electrode material 100 and the binder 200 are mixed to the extent that they are not deteriorated or destroyed. For example, the internal temperature of the mixer may be 200° C. or less, 180°° C. or less, 160° C. or less, or 140° C. or less.

When supplying the binder 200 to the electrode material 100, the binder 200 may be transferred in a state in which the temperature thereof is maintained at −20° C. to 100° C. Maintaining the temperature is not particularly limited, and for example, a jacket capable of controlling the temperature may be installed to a tank configured to store the binder 200 and/or a transfer line.

The mixture thus obtained may be transferred to a film forming device such as a roll press and heat and pressure may be applied to the mixture using the film forming device such as the roll press to form a film, thereby obtaining the electrode.

Transferring the mixture is not particularly limited, and the mixture may be transferred by vacuum transfer, gravity drop, etc.

The electrode may include a result obtained by applying heat and pressure to the mixture using a film forming device such as a roll press, or one obtained by laminating a plurality of the above results.

A better understanding of the present disclosure may be obtained through the following examples. These examples are merely set forth to illustrate the present disclosure, and are not to be construed as limiting the scope of the present disclosure.

### Example

An electrode material was obtained by mixing a cathode active material and a conductive material for about 5 minutes at a line speed of about 20 m/s. A mixture was obtained by mixing the electrode material and a copolymer derived from polytetrafluoroethylene for about 5 minutes at a line speed of about 20 m/s. The mass ratio of the cathode active material, conductive material, and copolymer derived from polytetrafluoroethylene in the mixture was set to 96:2:2.

The mixture was heated and pressed using a roll press, thereby manufacturing an electrode with the specifications shown in Table 2 below.

### Comparative Example 1

An electrode was manufactured in the same manner as in Example, with the exception that polytetrafluoroethylene homopolymer was used as the binder. The specifications of the electrode according to Comparative Example 1 are shown in Table 2 below.

### Comparative Example 2

An electrode was manufactured in the same manner as in Example, with the exception that a mixture of polytetrafluoroethylene homopolymer and a copolymer derived from polytetrafluoroethylene at a mass ratio of 1:1 was used as the binder.

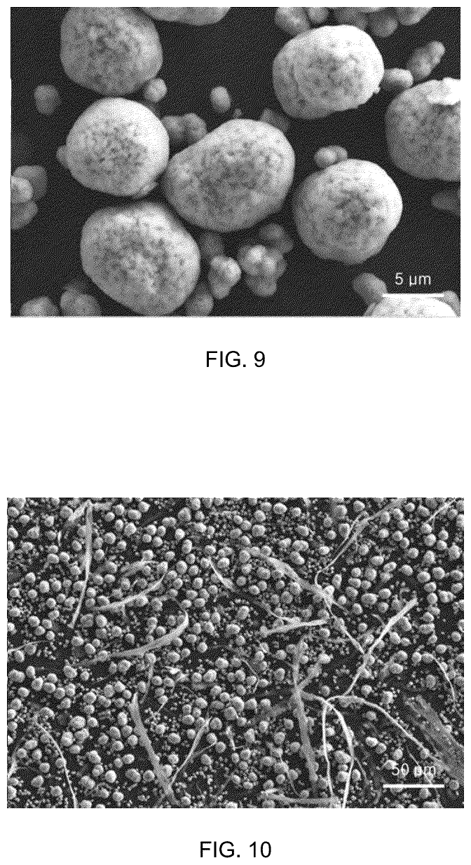

FIG. 8 shows the mixture according to Example analyzed using a scanning electron microscope. FIG. 9 shows the mixture according to Example analyzed using a scanning electron microscope at a different scale from FIG. 8.

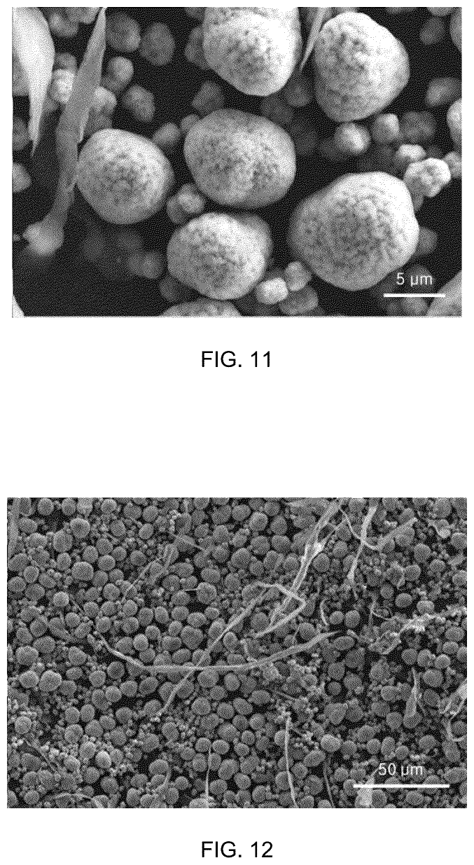

FIG. 10 shows the mixture according to Comparative Example 1 analyzed using a scanning electron microscope. FIG. 11 shows the mixture according to Comparative Example 1 analyzed using a scanning electron microscope at a different scale from FIG. 10.

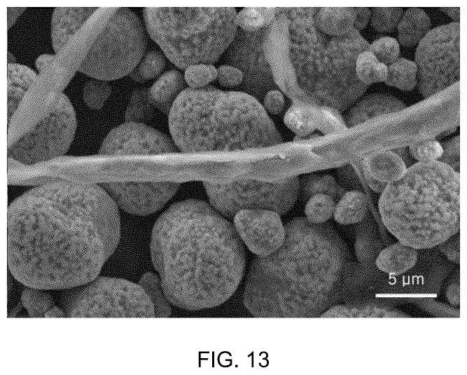

FIG. 12 shows the mixture according to Comparative Example 2 analyzed using a scanning electron microscope. FIG. 13 shows the mixture according to Comparative Example 2 analyzed using a scanning electron microscope at a different scale from FIG. 12.

Referring to FIGS. 8 and 9, no fibrillated binder was observed in the mixture according to Example, which is deemed to be because the surface of the electrode material was coated with the binder. Referring to FIGS. 10 and 11, in the mixture according to Comparative Example 1, the fibrillated binder was distributed between electrode materials. Thereby, it can be found that the binder according to the present disclosure is non-fibrillated and the surface of the electrode material is coated therewith. In order to use the binder fibrillation mechanism as in Comparative Example 1, various mixing processes have to be performed and mixing conditions have to be adjusted to control the extent of fibrillation. In contrast, when the binder fibrillation mechanism is not used as in the present disclosure, the electrode material may be easily coated with the binder by only applying energy at a predetermined line speed.

Meanwhile, referring to FIGS. 12 and 13, when the mixture of polytetrafluoroethylene homopolymer and copolymer derived from polytetrafluoroethylene was used as the binder, binder fibrillation was not sufficient and coating was not performed properly.

TABLE 2

| | | Electrode | Electrode | Electrode | Electrode | Loading |
|---|---|---|---|---|---|---|
| | | weight | thickness | area | capacity | amount |
| Classification | Electrode | [g] | [μm] | [cm²] | [mAh/g] | [mg/cm²] |
| Comparative | Cathode | 0.01280 | 80 | 0.785 | 223.85 | 16.3 |
| Example 1 | | | | | | |
| Example | Cathode | 0.01277 | 80 | 0.785 | 223.85 | 16.3 |

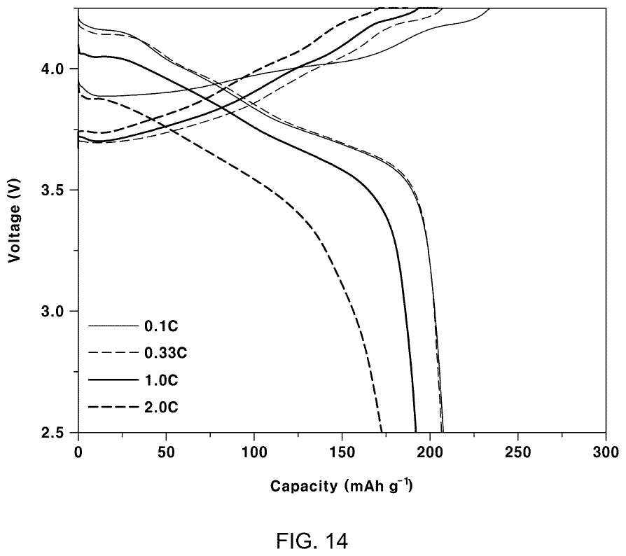

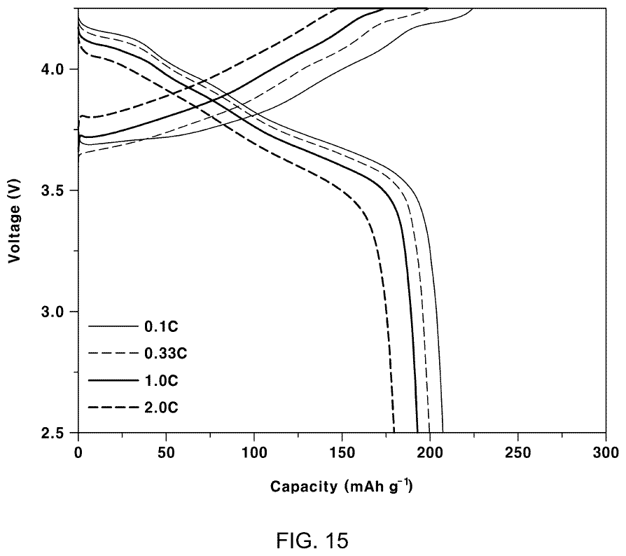

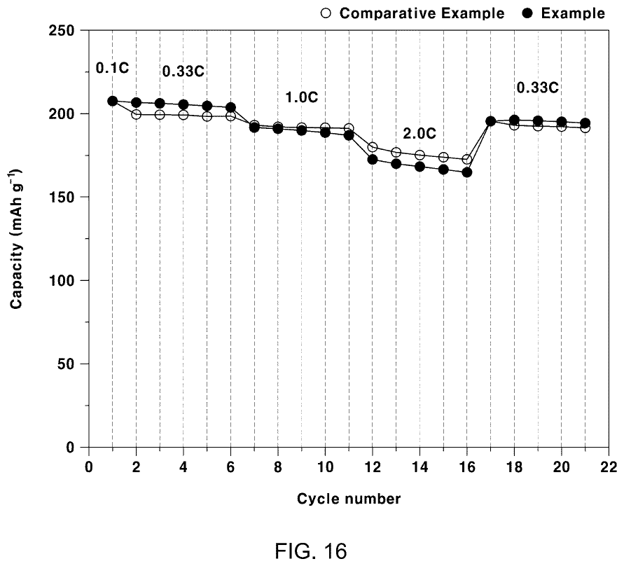

Respective coin cells were manufactured using the cathodes according to Example and Comparative Example 1 with the specifications as shown in Table 2, and the electrochemical test thereof was performed. FIG. 14 shows a voltage-capacity graph of the coin cell according to Example. FIG. 15 shows a voltage-capacity graph of the coin cell according to Comparative Example 1. FIG. 16 shows results of evaluation of rate characteristics of the coin cells according to Example and Comparative Example 1. Also, discharge capacities of Example and Comparative Example 1 are shown in Table 3 below.

TABLE 3

| | 0.1 C discharge | 0.33 C discharge |
|---|---|---|
| Classification | capacity [mAh/g] | capacity [mAh/g] |
| Comparative | 207.5 | 200.0 |
| Example 1 | | |
| Example | 207.7 | 206.5 |

Referring to FIGS. 14 to 16 and Table 3, performance of the coin cell according to Example was equal to or better than that of the coin cell according to Comparative Example 1. In general, the binder serves as a structural body that allows the electrode to maintain the structure thereof, but is a resistance component.

Considering that Example exhibited results equal to or better than Comparative Example 1, it can be found that the binder according to the present disclosure does not interfere with electron transfer between active materials even when the electrode material is coated therewith.

As is apparent from the above description, according to the present disclosure, a dry electrode for a lithium secondary battery that does not use a binder fibrillation mechanism and a dry manufacturing method thereof are provided.

According to the present disclosure, a dry electrode for a lithium secondary battery in which components are evenly distributed without layer separation and a dry manufacturing method thereof are provided.

According to the present disclosure, a dry electrode for a lithium secondary battery with excellent processability and a dry manufacturing method thereof are provided.

According to the present disclosure, a dry electrode for a lithium secondary battery that can be easily manufactured while exhibiting superior performance compared to existing dry electrodes and a dry manufacturing method thereof are provided.

The effects of the present disclosure are not limited to the foregoing. It should be understood that the effects of the present disclosure include all effects that can be inferred from the description of the present disclosure.

As the examples of the present disclosure have been described in detail above, the scope of the present disclosure is not limited to the aforementioned examples, and various modifications and improvements made by those skilled in the art using the basic concept of the present disclosure defined in the following claims are also within the scope of the present disclosure.

What is claimed is:

1. An electrode for a lithium secondary battery, the electrode comprising:
an electrode material comprising an active material; and
a binder with which the electrode material is coated,
wherein the binder comprises a copolymer derived from polytetrafluoroethylene (PTFE) and is non-fibrillated.

2. The electrode of claim 1, wherein the electrode material further comprises a conductive material.

3. The electrode of claim 1, wherein the electrode material further comprises at least one selected from the group consisting of a polymer electrolyte, an oxide-based solid electrolyte, a sulfide-based solid electrolyte, and combinations thereof.

4. The electrode of claim 1, wherein the binder has a Fourier transform infrared spectrum (FT-IR spectrum) showing a peak at a wavenumber of 980 cm⁻¹ to 1,000cm⁻¹.

5. The electrode of claim 1, wherein the binder comprises a compound represented by Chemical Formula 1 below: 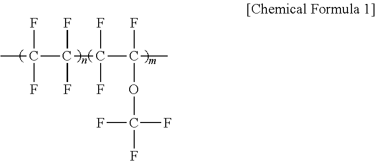
in Chemical Formula 1, each of n and m is a number from 10 to 1,000, R₁ is CF₃ or CₓF₂ₓ₊₁, and x is a number from 2 to 10.

6. The electrode of claim 5, wherein the compound represented by Chemical Formula 1 comprises about 10 wt % or less of R₁.

7. The electrode of claim 1, wherein the electrode does not comprise a fibrillated material.

8. The electrode of claim 1, wherein the electrode is a dry electrode.

9. The electrode of claim 1, wherein the electrode comprises about 0.1 wt % to 5 wt % of the binder.

10. A method of manufacturing an electrode for a lithium secondary battery, the method comprising:
mixing an electrode material comprising an active material and a binder to prepare a mixture in which the electrode material is coated with the binder; and
forming the mixture into a film to obtain an electrode,
wherein the binder comprises a derivative of polytetrafluoroethylene (PTFE) and is non-fibrillated.

11. The method of claim 10, wherein the electrode material is obtained by mixing and compounding the active material and a conductive material at a line speed of 20 m/s or more for 5 minutes or more.

12. The method of claim 10, wherein the electrode material further comprises at least one selected from the group consisting of a polymer electrolyte, an oxide-based solid electrolyte, a sulfide-based solid electrolyte, and combinations thereof.

13. The method of claim 10, wherein the mixture is prepared by mixing the electrode material and the binder at a line speed of 20 m/s or more for 5 minutes or more or until an internal temperature of a mixer reaches 80° C. or more.

14. The method of claim 10, wherein, when supplying the binder to the electrode material, a temperature of the binder is maintained at about −20° C. to about 100° C.

15. The method of claim 10, wherein the binder has a Fourier transform infrared spectrum (FT-IR spectrum) showing a peak at a wavenumber of about 980 cm⁻¹ to about 1,000 cm⁻¹.

16. The method of claim 10, wherein the binder comprises a compound represented by Chemical Formula 1 below: 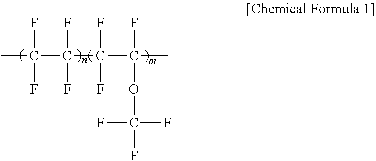
in Chemical Formula 1, each of n and m is a number from 10 to 1,000, R₁ is CF₃ or CₓF₂ₓ₊₁, and x is a number from 2 to 10.

17. The method of claim 10, wherein the film is formed by applying heat and pressure to the mixture using a roll press.

18. The method of claim 10, wherein the electrode does not comprise a fibrillated material.

19. The method of claim 10, wherein the electrode is a dry electrode.

20. The method of claim 10, wherein the electrode comprises about 0.1 wt % to about 5 wt % of the binder.
